(19) United States
(12) Patent Application Publication
(10) Pub. No.: US 2025/0384110 A1
(43) Pub. Date: Dec. 18, 2025

(54) PROTOCOLS FOR GAME-THEORETICALLY-FAIR OPERATOR ELECTION IN BLOCKCHAIN SETTINGS

(71) Applicant: NTT Research, Inc., Sunnyvale, CA (US)

(72) Inventors: ILAN KOMARGODSKI, Tel Aviv (IL); SHINICHIRO MATSUO, Washington, DC (US); RUNTING SHI, Pittsburg, PA (US); KE WU, Ann Arbor, MI (US)

(73) Assignee: NTT Research, Inc., Sunnyvale, CA (US)

(21) Appl. No.: 18/878,065

(22) PCT Filed: Jun. 22, 2023
(86) PCT No.: PCT/US2023/068889

§ 371 Date: Dec. 22, 2024

Related U.S. Application Data
(60) Provisional application No. 63/354,642, filed on Jun. 22, 2022.

(51) Int. Cl. G06F 17/18

(52) U.S. Cl. CPC G06F 17/18

(57) ABSTRACT

The disclosure relates to storing blockchain blocks committed to a blockchain based on a committee selection protocol executed in the presence of majority-sized coalitions while achieving a meaningful fairness guarantee in a small number of rounds, and whose round complexity is less than log log n, and storing a new block to the blockchain based on a protocol executed by the nodes of the next committee.

### CROSS-REFERENCE TO RELATED APPLICATION

This application claims the benefit of U.S. Provisional Application Ser. No. 63/354,642 filed Jun. 22, 2022, the content of which is incorporated by reference herein in its entirety.

### FIELD OF THE INVENTION

The invention relates generally to round complexity of game-theoretically fair leader election, and in particular committee election for use in blockchain settings.

### BACKGROUND OF THE INVENTION

It is well-known that in the presence of majority coalitions, strongly fair coin toss is impossible. A line of recent works have shown that by relaxing the fairness notion to game theoretic, we can overcome this classical lower bound. In particular, it is known how to achieve approximately (game-theoretically) fair leader election in the presence of majority coalitions, with round complexity as small as O(log log n) rounds.

A recent line of work has shown that a relaxed fairness notion called game-theoretic fairness is indeed possible for the leader election problem, even when an arbitrary number of parties may be corrupt. To see why, first observe that the original Blum's coin toss protocol actually gives a game-theoretically fair leader election scheme for n=2 parties. Imagine that each party first commits to a random coin, they then open their coin, and the XOR of the two bits is used to elect a random winner. If one party fails to commit or correctly open, it is eliminated and the remaining party is declared the winner. Blum's coin toss satisfies game-theoretic fairness in the following sense. As long as the commitment scheme is not broken, a corrupt layer cannot bias the coin to its own favor no matter how it deviates from the protocol. Note that Blum's protocol is not strongly fair since a corrupt party can indeed bias the coin, but only to the other player's advantage.

For the more general case of the n parties, we can use a folklore tournament-tree protocol to accomplish the same purpose. Suppose that n is a power of 2 for simplicity. We first divide the n parties into n/2 pairs, and each pair elects a winner using Blum's coin toss. The winner survives to the next round, where we again divide the surviving n/2 parties into n/4 pairs. The protocol continues after a final winner is elected after log₂ n rounds. At any point in the protocol, if a party fails to commit or correctly open its commitment, it is eliminated and its opponent survives to the next round.

Recent work of Chung et al. argued that this simple tournament tree protocol satisfies a strong notion of game-theoretic fairness as explained below. Suppose that the winner obtains a utility of 1 and everyone else obtains a utility of 0. As long as the commitment scheme is not broken, the tournament tree protocol guarantees that 1) no coalition of any size can increase its own expected utility no matter what (polynomially-bounded) strategy it adopts; and 2) no coalition of any size can harm any individual honest player's expected utility, no matter what (polynomially-bounded) strategy it adopts. Other recent work in this space calls the former notion cooperative-strategy-proofness (or CSP-fairness for short), and calls the latter notion maximin fairness. Philosophically, CSP-fairness guarantees that any rational, profit-seeking individual or coalition has no incentive to deviate from the honest protocol; and maximin fairness ensures that any paranoid individual who wants to maximally protect itself in the worst-case scenario has no incentive to deviate either. In summary, the honest protocol is an equilibrium and also the best response for every player and coalition. Therefore, some prior works have argued that game-theoretic notions of fairness are compelling and worth investigating because 1) they are arguably more natural (albeit strictly weaker) than the classical strong fairness notion in practical applications; and 2) the game-theoretic relaxation allows us to circumvent classical impossibility results pertaining to strong fairness in the presence of majority coalitions.

Some recent efforts have instigated the intersection of the game theory and multi-party computation. There have been two classes of questions that have attracted a lot of interests.

Some works explore how to define game-theoretic notions of security, as opposed to cryptography security notions for distributed computing tasks such as secure function evaluation. Existing works in this line considered a different notion of utility than our work. Their utility functions are often defined assuming that players prefer to compute the function correctly, or prefer to learn others' secret data and prefers that other players do not gain knowledge about their own secrets. Garay et al. propose a paradigm called Rational Protocol Design and develop this paradigm in subsequent works. As discussed herein, the standard notion of approximate CSP-fairness (or maximin fairness) is in some sense equivalent to the approximate notion of fairness formulated in RPD paradigm.

Another line of work explores how cryptography can help traditional game theory. Many works in game theory assumed the existence of a trusted mediator, which can be realized under cryptography.

Recently, there has been renewed interest in the connection between game theory and cryptography. Besides the work of Chung et al., and that generalized the lower bound of the round complexity of game-theoretically fair leader election, other recent work has also suggested game-theoretically fair multi-party binary-coin toss. Binary-coin toss considers tossing a binary coin among n players, while in leader election, we consider tossing an n-way coin among n players. These two formulations are different and they exhibit starkly different theoretical landscape.

Leader election has been studied extensively. A line of work considered how to achieve “financially-fair” n-party lottery over cryptocurrencies. Their game-theoretic notion of fairness is similar to ours, yet they rely on collateral and penalty mechanisms to achieve fairness. As a comparison, our fairness can be achieved without relying on additional assumptions such as collateral and penalty. Moreover, other work studied an incomparable game-theoretic notion for leader election. In their notions, all users prefer to have a leader, and users may have different preferences of who the leader is.

Besides, leader election was considered in the full information model. Their notion of security concentrates on electing an honest leader with some small constant probability, assuming honest majority. This notion is much weaker than the game-theoretic notion considered in our work, which are more suitable in some decentralized applications, where honest majority assumption is not applicable. Moreover, in the full-information model, leader election is impossible against a majority coalition even under this weak notion of security. Interestingly, our committee election protocol actually builds on Feige's lightest bin protocol.

As described herein, the de facto notion of fairness considered in the multi-party computation literature is strong fairness or unbiasability. The celebrated result of Cleve showed that it is not possible to achieve

$$Ω ( \frac{1}{R} ) -$$

unbiasable coin toss against a coalition consisting of half or more players. Moran et al. showed how to obtain an R-round protocol that achieves

$$Ω ( \frac{1}{R} ) -$$

unbiasability in the two-party setting, that matches Cleve's lower bound. Recent work has been making encouraging progress on building fair multi-party coin toss. However, they rely on constant number of players to ensure polynomial round complexity. We cannot directly rely on multi-party unbiasable coin toss to build game-theoretically fair leader election because our trade-off curve between round complexity and the fairness slack E is exponentially better than that of the unbiasability.

Having established the general feasibility of game-theoretically fair leader election in the presence of majority-sized coalitions, Chung et al. asked the following natural question: what is the round complexity of game-theoretically fair leader election in the presence of majority coalitions?Specifically, can we asymptotically outperform the log-arithmic round complexity of the folklore tournament tree protocol? They then gave a partial answer to this question, showing that for any desired round complexity parameter Θ(log log n)≤R≤log n, there is an O(R)-round n-party leader election protocol that achieves

$$( 1 - \frac{1}{{2}^{⊖ ( R )}} ) -$$

fairness against coalitions of size up to

$$( 1 - \frac{1}{{2}^{⊖ ( R )}} ) n .$$

In particular, their result statement adopts an approximate notion of game-theoretic fairness. Roughly speaking, a protocol is (1−ϵ)-fair if it satisfies the aforementioned game theoretic fairness (including CSP-fairness and maximin fairness) up to an E slack. More specifically, we want that the coalition's expected utility cannot exceed 1/(1−ϵ) times its normal utility had everyone behaved honestly, and we require that any honest individual's expected utility cannot drop below (1−ϵ) times its normal utility had everyone behaved honestly. Chung et al.'s result enables a smooth and mathematically quantifiable tradeoff between the efficiency of the protocol and its resilience to strategic behavior. However, their result requires the protocol to have at least Θ(log log n) rounds to give any meaningful fairness guarantee. Indeed, a more careful examination suggests that their framework has a sharp cutoff at Θ(log log n) rounds, i.e., the approach fundamentally fails when we want round complexity to be less than log log n. Therefore, a gap in our understanding is the following: In the presence of majority-sized coalitions, can we achieve any meaningful fairness guarantee for small-round protocols whose round complexity is less than log log n.

### BRIEF SUMMARY OF THE INVENTION

As described herein, we revisit the round complexity of game-theoretically fair leader election. We construct O(log*n) rounds leader election protocols that achieve (1−o(1))-approximate fairness in the presence of (1−o(1))n-sized coalitions. Our protocols achieve the same round-fairness trade-offs as Chung et al.'s and have the advantage of being conceptually simpler. Finally, we also obtain game-theoretically fair protocols for committee election which might be of independent interest.

In this application, we revisit the round complexity of game-theoretically fair leader election. We make the following contributions. First, we show positive results in the style of Chung et al., but now for a broader range of parameters as explained in the following Theorem 0.1. In particular, our result shows that under standard cryptographic assumptions, there is a O(log*n)-round leader election protocol that achieves (1−o(1))-game-theoretic-fairness, in the presence of (1−o(1))·n-sized coalitions.

Second, we give conceptually simpler constructions than those of Chung et al., which also result in simpler analyses. More specifically, Chung et al.'s construction relies on combinatorial objects called extractors, which we get rid of in our construction. We believe that our conceptually simpler constructions can lend to the understanding and make it easier for future work to extend our framework. Interestingly, our constructions are inspired and have structural resemblance to Feige's famous lightest bin leader election protocol. We stress, however, that Feige's protocol itself does not satisfy game-theoretic fairness, but rather, achieves only a much weaker notion of resilience, i.e., an honest party is elected leader with constant probability. At a very high level, our approach augments Feige's protocol lightest-bin protocol with a “commit and open” and a “virtual identity” mechanism, and we prove that the resulting protocol satisfies the desired game-theoretic properties.

Third, we also present results for the more generalized problem of fair committee election, where the goal is to elect a committee of size c. The leader election problem can be viewed as a special case of committee election where c=1. Our main results are summarized in the following theorems.

Theorem 0.1 (Game-theoretically fair leader election). Assume the existence of enhanced trapdoor permutations, and collision-resistant hash functions. Fix n and let log*n≤R≤C log n be the round complexity we want to achieve for some constant C. Then there exists an O(R)-round leader election that achieves

$$( 1 - \frac{1}{{2}^{⊖ ( R )}} )$$

game-theoretic fairness against a non-uniform p.p.t. coalition of size at most

$$( 1 - \frac{L}{⊖ ( R )} ) n ,$$

where L is the smallest integer such that log^{(L)}n≤2R.

For readers who are familiar with the line of work on approximate strong fairness, an interesting observation is that for game-theoretic fairness, the efficiency-fairness tradeoff is exponentially better than that of strong fairness. Specifically, it is known that any R-round protocol cannot achieve Ω(1/R) strong fairness against an n/2-sized coalition, whereas we show that R-round protocols can achieve (1-1/2^{Θ(R)})-fairness. The approximate strong fairness line of work defines what we call (1−ϵ)-fairness as ϵ-fairness (but for the notion of strong fairness instead). Following the notations of Chung et al., we flipped this notation to make it more intuitive: with our notation, 1-fair is more fair than 0-fair which agrees with our intuition.

Theorem 0.2 (Game-theoretically fair committee election). Assume the existence of enhanced trapdoor permutations and collision-resistant hash functions. Fix n and c. Let L* be the smallest integer such that log^{(L*)}n≤c^{0.1}. Then for any L*≤R≤C₀ log n for some constant C₀, we have that
If c≥2^{10R} there exists an O(R)-round committee election that achieves

$$( 1 - \frac{1}{{c}^{⊖ ( 1 )}} )$$

game-theoretic fairness against a non-uniform p.p.t. coalition of size at most

$$( 1 - \frac{L *}{⊖ ( R )} ) n .$$

If c<2^{10R} there exists an O(R)-round committee election that achieves

$$( 1 - \frac{1}{{2}^{⊖ ( R )}} )$$

game-theoretic fairness against a non-uniform p.p.t. coalition of size at most

$$( 1 - \frac{L}{⊖ ( R )} ) n ,$$

where L is the smallest integer such that log^{(L)} n≤2^{R}.

In this application, we consider the standard notions of approximate CSP-fairness and maximin-fairness. The standard notion of approximate CSP-fairness is also sometimes referred to as approximate coalition-resistant Nash equilibrium in some earlier works such as Fruitchain. It is also known that the standard notion of approximate CSP-fairness (or maximin-fairness) is equivalent in some sense to approximate notions of fairness formulated by the more classical Rational Protocol Design (RPD) paradigm.

Although the standard notion of approximate fairness seems the most natural one, Chung et al. pointed out that when defining approximate fairness, one can in fact adopt a strengthened notion which they call sequential fairness. Their game-theoretically fair leader election result is in fact stated for the sequential notion. In this sense, our result is incomparable to theirs: they consider a stronger solution concept but their approach inherently cannot give any meaningful result for protocols of o(log log n) rounds. By contrast, we consider the more standard non-sequential notion and we are able to generalize the smooth tradeoff between efficiency and fairness shown by Chung et al. to a broader range of parameters.

Some embodiments of the invention include systems, methods, network devices, and machine-readable media for storing blockchain blocks committed to a blockchain based on a protocol executed by a committee of a blockchain network;
storing c as an upper bound of the size of the committee and n as a number of participants in the committee selection process;
storing

$$B = ⌈ \frac{n}{c} ⌉$$

as a number of bins, wherein c divides n;
establishing a publicly verifiable concurrent non-malleable commitment NMC; executing a protocol, the protocol comprising:
   (a) in a first round, every participant i randomly chooses a bin bᵢ∈[B], invoking n NMC instances and executing a commit phase with n receivers to commit to bᵢ;
      every participant transmitting commit phase messages in a broadcast channel; excluding any participants that fail to commit;
   (b) in a second round, every participant i executing an opening phase with n receivers to open its bin choice bᵢ;
      excluding those participants who fail to open all n instances correctly;
establishing \hat{b} as the lightest bin after exclusion;
establishing the participants who choose bin b as constituting the committee; and storing a new block to the blockchain based on a protocol executed by the nodes of the committee.

Another embodiment includes storing blockchain blocks committed to a blockchain based on a protocol executed by a committee of a blockchain network;
a memory configured to store blockchain blocks committed to a blockchain based on a protocol executed by a committee of a blockchain network; and
a processor configured for selecting the committee by:
storing blockchain blocks committed to the blockchain based on a protocol executed by the committee of the blockchain network;
storing c as an upper bound of the committee and n is a number of participants;
storing

$$B = ⌈ \frac{n}{c} ⌉$$

as the number of bins, wherein c divides n;
establishing [symbol] as [n] that denotes a set of active participants;
establishing β·n as a maximum size of a coalition for β∈(0,1);
establishing a publicly verifiable concurrent non-malleable commitment NMC;
executing a protocol, the protocol comprising:
   (a) every participant i randomly choosing a string vᵢ←{0, 1}^{λ} as its virtual ID, invoking n instances of NMC, and executing a commit phase with n receivers to commit to (i, vᵢ), wherein those participants who fail to commit are excluded;
   (b) each participant randomly choosing a bin bᵢ←[B] with fresh randomness, and
      setting mᵢ=(bᵢ, vᵢ);
      broadcasting mᵢ using

$${ℱ}_{anon}^{t , 𝒪}$$

with t=└(1−β)n┘;
if the output is (fail, [symbol] ), excluding the participants in [symbol] from [symbol] by setting [symbol] = [symbol] \ [symbol] ;
the remaining participants in the updated [symbol] re-run step b.
if the output is (ok, Out), go to the next step;
(c) establishing b* as the lightest bin;
   every participant opening its virtual ID (i, vᵢ);
   establishing U_{b*} as the set of virtual IDs that are unique and choosing the lightest bin b*;
   establishing the committee as those who open the (i, vᵢ) successfully with vᵢ∈U_{b*}; and
storing a new block to the blockchain based on a protocol executed by the nodes of the committee.

In some further embodiments, the committee and a next committee comprise different respective subsets of nodes from among a larger set of nodes included in the blockchain network. In some further embodiments, the blockchain blocks comprise firstborn blocks created by the nodes of the committee. In some further embodiments the committee is 1-sized.

### BRIEF DESCRIPTION OF THE DRAWINGS

The accompanying drawings, which are included to provide further understanding and are incorporated in and constitute a part of this specification, illustrate disclosed embodiments, and together with the description, serve to explain the principles of the disclosed embodiments. In the drawings:

FIG. 1 is a diagram illustrating an example blockchain architecture configuration, according to example embodiments.

FIG. 2 is a diagram illustrating an example system that supports one or more of the example embodiments.

### DETAILED DESCRIPTION

### 1 Technical Roadmap

### 1.1 Electing Poly-Logarithmically Sized Committees: Achieving CSP-Fairness

We start by observing that a single iteration of Feige's lightest-bin protocol can elect a committee of size c≥poly log n while satisfying CSP-fairness against relatively large coalitions. Feige's ingenious protocol works as follows (we describe a single iteration of the protocol): each player i∈[n] chooses a random bin bᵢ among a total of B=n/c bins, and broadcasts its choice bᵢ. At this moment, we identify the lightest bin, and everyone who has placed itself in the lightest bin is elected as a committee member. A simple analysis shows that this protocol satisfies CSP-fairness against relatively large coalitions. Specifically, the lightest bin cannot exceed a capacity of c=n/B. Moreover, applying the standard Chernoff bound and the union bound, we know that with probability at least 1−n·exp(−Ω(ϵ⁴·c)), a good event that every bin has at least (1−ϵ²)·(1−β)·c honest players must happen, where β·n is the maximum coalition size for β∈(0, 1). Now we show that if the coalition has size larger than ϵ−n, then Feige's lightest bin is (1−Θ(ϵ))-CSP-fair. Given that the good event happens, the expected fraction of corrupted players in the committee is at most

$$1 - ( 1 - {ϵ}^{2} ) \cdot ( 1 - β ) \leq \frac{β}{1 - 2 ϵ} .$$

For large n, it is easy to see that the good event happens with 1−negl(n) probability and the expected fraction of coalition in the committee is at most

$$\frac{β}{1 - Θ ( ϵ )} .$$

For small n, however, the calculation is more involved, as we will describe below. The overall expected fraction of the coalition in the committee is at most

$$\frac{β}{1 - 2 ϵ} + δ ,$$

where δ=n·exp(−Ω(ϵ⁴·c)) is the probability that the good event does not happen. To guarantee that the expected fraction of the coalition in the committee is at most

$$\frac{β}{1 - Θ ( ϵ )} ,$$

need the failure probability δ≤β·Θ(ϵ). The expected fraction of the coalition in the committee is thus

$$\frac{β}{1 - 2 ϵ} + δ \leq β ( \frac{1}{1 - 2 ϵ} + Θ ( ϵ ) ) \leq \frac{β}{1 - Θ ( ϵ )} .$$

For example, if we pick

$$ϵ = \frac{1}{log n} and c = {( log n )}^{10} ,$$

then the probability that the good event does not happen is at most n exp{−Ω(log n⁶)}≤ϵ²≤β·ϵ for any n≥3. Henceforth the protocol satisfies (1−Θ(ϵ))-CSP-fairness as long as the coalition contains at least ϵn players.

Unfortunately, the protocol does not satisfy CSP-fairness for small coalitions. For example, a single individual i∈[n](i.e., a coalition of size 1) can examine all others' bin choices and then decide to place itself in the lightest bin. In this case, if the lightest bin (not counting player i) is at least 2 lighter than the second lightest bin, player i is elected into the committee. This happens with a probability at least

$$\frac{6}{5} \cdot \frac{c}{n}$$

for large n, which is significantly higher than the normal probability c/n that player i ought to be elected in an all-honest execution.

Commit-and-reveal lightest bin. We introduce commit-and-reveal version of Feige's lightest bin protocol which achieves CSP-fairness not just against large coalitions, but also against small coalitions as well. The idea is quite simple—below we describe the scheme assuming ideal commitments, although in our formal technical sections we will instantiate the commitments using standard non-malleable commitments. Everyone first commits to a random bin number among B=n/c bins. They then open their commitments. Those who land in the lightest bin are declared the committee, and like before, anyone who fails to commit or correctly open is kicked out. Using the same argument as before, we can show that the commit-and-reveal lightest bin protocol also achieves (1−Θ(ϵ))-CSP-fairness against coalitions of size at least ϵn.

We now argue why it also satisfies CSP-fairness against small coalitions of size βn<ϵn. Intuitively, the coalition's best strategy is to pick a bin with the fewest number of honest players (henceforth called the honest-lightest bin), and place as many coalition members in it as possible while still maintaining that it is the lightest. However, the coalition does not know which one is the honest-lightest bin when committing to its own bin choices. In fact, even when conditioned on the coalition's view during the commitment phase, each bin is the honest-lightest bin with equal probability. No matter how the coalition spreads its members across the bins, the expected number of coalition members in a randomly chosen bin is at most β·n/B=β·c. Further, with 1−n·exp(−Ω(ϵ⁴·c)) probability, the good event that honest-lightest bin should have at least (1−ϵ²)(1−β)c honest players happens. Therefore, the coalition's expected representation on the committee cannot exceed

$$\frac{β}{( 1 - {ϵ}^{2} ) ( 1 - β )} \leq \frac{β}{1 - 2 ϵ}$$

given that the good event happens. Overall, the expected fraction of the coalition in the committee is at most

$$\frac{β}{1 - 2 ϵ} + δ ,$$

where δ=n·exp(−Ω(ϵ⁴·c)) is the probability that the good event does not happen. Still, as long as δ≤βϵ, by the same analysis as before, the expected fraction of the coalition in the committee is at most

$$\frac{β}{1 - Θ ( ϵ )} .$$

### 1.2 Electing Poly-Logarithmically Sized Committees: Achieving Maximin Fairness

Although simple and cute, the commit-and-reveal lightest bin protocol does not satisfy maximin fairness. For example, a Θ(n)-sized coalition can target a victim player i∈[n] and prevent it from being elected with high probability using the following strategy. During the commitment phase, spread the coalition members evenly across all bins. During opening, first observe which bin (denoted b*) player i lands in. Then, all coalition members fail to open except those whose choice was b*.

To achieve maximin fairness, we are inspired by a virtual identity technique originally proposed by Chung et al., but unfortunately, directly applying this idea to the lightest bin does not work. At a high level, a strawman idea is as follows:
1. Every player i∈[n] selects a random virtual identity vᵢ from a sufficiently large space, and commits to the pair (i, vᵢ).
2. Every player i∈[n] selects a random bin bᵢ among B=n/c bins, and commits to the pair (vᵢ, bᵢ) where vᵢ is its secret virtual identity.
3. Everyone i∈[n] opens their commitment of (vᵢ, bᵢ). The virtual identities contained in the lightest bin will be elected committee.
4. Everyone opens their real-virtual identity mapping (i, vᵢ). This will allow everyone to compute the real identities of those elected to the committee.

Now, as long as the coalition does not know an honest player i's virtual ID, it does not know who to target during the commit-and-reveal lightest bin steps (Steps 2 and 3). Therefore, as long as the good event that each bin contains at least (1−ϵ)(1−β)c honest players happens, an honest player i will be elected into the committee with probability at least

$$\frac{( 1 - ϵ ) ( 1 - β ) c}{( 1 - β ) n} = \frac{( 1 - ϵ ) c}{n} .$$

By law of total probability, the probability that an honest player i gets elected into the committee with probability at least

$$\frac{( 1 - ϵ ) ( 1 - δ ) c}{n} ,$$

where 1−δ is the probability that the good event happens. Henceforth, as long as δ≤ϵ, an honest player i gets elected into the committee with probability at least

$$\frac{( 1 - Θ ( ϵ ) ) c}{n} .$$

Unfortunately, this idea does not work if the coalition can eavesdrop on the network channel and observe who sent which (bin, virtual ID) pair in the commit-and-reveal lightest bin protocol. This would allow the coalition to immediately learn the correspondence between virtual and real identities.

To salvage this idea, our high-level idea is simple but realizing it turns out to be somewhat subtle as we explain later. First, if we are willing to assume the existence of an idealized anonymous communication network where players can post messages anonymously, then we can overcome the aforementioned problem by running Steps 2 and 3 over an anonymous communication network. Therefore, it suffices to find a suitable anonymous communication protocol to realize anonymous communication. Although anonymous communication has been extensively studied in the literature, in our setting, it is tricky to adopt existing schemes directly. The main technicality is that in the presence of a majority coalition, we cannot guarantee the liveness of the anonymous communication protocol.

To overcome this problem, one naïve idea is to rely on an anonymous communication protocol with identifiable abort, and if the protocol fails, we kick out an offending player and retry. Unfortunately, the vanilla notion of identifiable abort does not work for us because we cannot afford to kick out offending players one by one since we are aiming for small round complexity. Our idea is to devise an anonymous communication protocol not just with identifiable abort, but with with plentiful identifiable aborts. In other words, if the protocol fails, we want to kick out sufficiently many players, such that we can eventually succeed without too many retries.

Therefore, we adapt an anonymous communication protocol inspired by DC-nets to achieve such a plentiful identifiable abort notion. Assuming an upper bound of βn on the coalition size, our protocol kicks out at least (1−β)n players in the event of failure. Thus the round complexity is at most

$$\frac{1}{1 - β} .$$

For example, if β=99%, we can still succeed in O(1) rounds.

### 1.3 Leader Election

Although the lightest bin protocol via anonymous broadcast (denoted as LBin-V below) achieves CSP-fairness and maximin-fairness simultaneously, it cannot be directly used to select a leader, i.e., c=1. Indeed, the fairness of LBin-V depends on the occurrence of the good event that each bin has at least (1−ϵ²)(1−β)c number of honest players, where β·n is the maximum coalition size for β∈(0, 1). If we are to choose a leader directly using LBin-V, then the probability that this good event happens is 0, which makes our protocol unfair.

To construct a leader election protocol, we compose the committee election LBin-V for multiple iterations. In each iteration: we choose a log-sized committee. In the first iteration we choose a poly log-sized committee [symbol] ₁, and then in the second iteration we choose a poly log log sized committee [symbol] ₂ from [symbol] ₁, and so on. As analyzed earlier, each iteration of LBin-V is (1−Θ(ϵ))-game-theoretically fair given that the failure probability δ that the good event does not happen in this iteration is small compare to β·ϵ.

However, as the committee size becomes smaller in each iteration, the probability that the good event does not happen becomes larger. In the last few rounds, when the committee becomes constant size, the probability that the good event does not happen becomes a constant. Therefore, we need to cut off at some point and instead run the “almost perfect” tournament tree protocol. As shown in Chung et al., the tournament tree protocol among c players chooses a leader in O(log c) rounds and is (1−negl)-game-theoretically fair. If we want to achieve a round complexity of R, then we can stop running LBin-V when the committee size becomes smaller than 2^{Θ(R)} and run the tournament tree protocol among the committee to elect a leader.

Now suppose that we run L iterations of committee election LBin-V and get a committee of size 2^{Θ(R)}. Then we need to guarantee that the round complexity of these L iterations of LBin-V is at most O(R). By the analysis above, if we kick out (1−β)n players in each anonymous communication protocol, the round complexity of each LBin-V is at most

$$\frac{1}{1 - β} .$$

This requires that the fraction of coalition

$$β \leq 1 - \frac{L}{Θ ( R )} .$$

Now since the probability that the good event does not happen increases in each iteration, the probability that there is an iteration in which the good event does not happen is dominated by L·δ_{L}, where δ_{L}=exp{−ϵ⁴·2^{-Θ(R)}} is the probability that good event does not happen in the last iteration. As long as this probability is smaller than β·ϵ, the protocol is (1−Θ(ϵ))-fair. Picking

$$ϵ = \frac{1}{{2}^{R}}$$

suffices. Therefore, if we run LBin-V multiple iterations to elect a committee C of size is 2^{Θ(R)}, and then run the tournament tree protocol among C to elect a leader, our leader election protocol achieves

$$( 1 - \frac{1}{{2}^{Θ ( R )}} )$$

game-theoretic fairness.

In Section 4, we give a generalized protocol that combines multiple iterations of LBin-V and the tournament tree protocol to elect an arbitrary-sized committee, including the special case of committee size 1, i.e., leader election.

### 2 Preliminaries

Notation. Throughout, we use λ to denote the security parameter. The notation lo [symbol] n means taking logarithm [symbol] times over n. For example, log⁽³⁾ n≡log log log n. Moreover, we use log*n to denote the smallest integer [symbol] such that log [symbol] n≤1. For an event E, we denote Ē as the event that E does not happen. For a vector X of length M, we use X[j] for j∈[M] to denote the j-th element of X. By t-out-of-n SS, we refer to a Shamir secret sharing protocol in which any t+1 players can reconstruct the secret, while any t players know nothing about the secret. We use the acronym p.p.t. for non-uniform probabilistic polynomial time. We use {X_{λ}}_{λ}≡_{c}{Y_{λ}}_{λ} to denote that two distribution ensembles {Xa}_{λ} and {Ya}_{λ} are computationally indistinguishable, i.e., for all non-uniform p.p.t. [symbol] , there exists a negligible function negl(⋅), such that for any λ∈ [symbol] , |Pr[x [symbol] Xₙ, [symbol] (x)=1]−Pr[y [symbol] Uₙ, [symbol] (y)=1]|<negl(λ).

### 2.1 Probability Tools

Lemma 2.1 (Chernoff bound, Corollary A.1.14). Let X₁, . . . , Xₙ be independent Bernoulli random variables. Let

$$μ = 𝔼 [ {\sum }_{i = 1}^{n} {X}_{i} ] .$$

Then, for any ϵ∈(0,1), it holds that

$$P r [ {\sum }_{i = 1}^{n} {X}_{i} \leq ( 1 - ϵ ) μ ] \leq {e}^{- {ϵ}^{2} μ / 2} .$$

### 2.2 Fairness Notions for Committee Election

Since a leader is a special case of a 1-sized committee, we will define correctness and fairness with respect to committee election protocol.

In a (c, n)-committee election protocol, n players interact through pairwise private channels and a public broadcast channel. We assume that each player has identity 1, 2, . . . , n, respectively. We assume that all communication channels are authenticated, i.e., messages carry the sender's identity. Moreover, the network is synchronous, and the protocol proceeds in rounds.

The protocol execution is parametrized with the security parameter λ. We assume that the coalition (adversary) A performs a rushing attack. In every round r, it waits for all honest players (those not in A) to send messages in round r and decide what messages the players in the coalition send in round r. At the end of the committee election, the protocol outputs a set of at most c players called the committee. The output is defined as a deterministic, polynomial-time function over all public messages posted to the broadcast channel. Since we assume that all players wish to be selected into the committee, the utility function we consider is as follows: each player elected into the committee gains a utility of 1, while everyone else gains a utility of 0. If all players behave honestly, the committee is chosen uniformly at random.

Correctness. We say that a (c, n)-committee election protocol is correct, if in an all honest execution, every subset C⊂[n] of size c has an equal probability of being elected as the committee, where the probability is taken over the randomness of (an honest execution) the protocol.

For the fairness notion, we recall the definitions proposed by Chung et al. The first notion of fairness (CSP-fairness) protects against a malicious coalition from increasing its utility. The second notion (maximin-fairness) protects against a malicious coalition from decreasing the utility of any honest party. Each of these notions is natural and useful on its own, and in some sense, they complement each other. A protocol that satisfies both simultaneously is called game-theoretically fair.

Approximate CSP-fairness. The CSP-fairness requires that no coalition can increase its own expected utility by more than a (1−ϵ) multiplicative factor, no matter how it deviates from the honest protocol.
Definition 2.2 ((1−ϵ)-CSP-fair committee election). A (c, n)-committee election is (1−ϵ)-CSP-fair against a non-uniform probabilistic polynomial time (p.p.t.) coalition A of size βn, iff no matter what strategy A adopts,

$$𝔼 [ \tilde{β} ] \leq \frac{β}{1 - ϵ} ,$$

where \tilde{β} is the fraction of players in the coalition among the committee, where the expectation is taken over the randomness of the protocol.
Definition 2.3 ((1−ϵ, δ)-CSP-fair committee election). A (c, n)-committee election is (1−ϵ, δ)-CSP-fair against a non-uniform probabilistic polynomial time (p.p.t.) coalition A of size βn, if there exists an event GOOD, where Pr[GOOD]≥1−δ, such that no matter what strategy A adopts,

$$𝔼 [ \overline{β} \vert GOOD ] \leq \frac{β}{1 - ϵ} ,$$

where \tilde{β} is the fraction of the coalition's representation in the committee, and the expectation is taken over the randomness of the protocol.

Analogously, we define (1−ϵ)-maximin-fair and (1−ϵ, δ)-maximin-fair committee election, which requires that the probability that an honest individual gets into the committee is large enough given that the good event happens.

Approximate maximin-fairness. Maximin-fairness requires that no coalition can harm any honest individual by more than a (1−ϵ) multiplicative factor, no matter how it deviates from the honest protocol.
Definition 2.4 ((1−ϵ)-maximin-fair committee election). A (c, n)-committee election is (1−ϵ)-maximin-fair against a non-uniform probabilistic polynomial time (p.p.t.) coalition A of size βn, iff for any honest individual i, the probability that i gets into the committee is

$$Pr [ i is in the committee ] \geq \frac{( 1 - ϵ ) c}{n} ,$$

no matter what strategy A adopts. The probability is taken over the randomness of the protocol.
Definition 2.5 ((1−ϵ, δ)-maximin-fairness). A (c, n)-committee election is (1−ϵ, δ)-maximin-fair against a non-uniform probabilistic polynomial time (p.p.t.) coalition A of size βn, if there exists an event GOOD, where Pr[GOOD]≥1−δ, such that no matter what strategy A adopts,

$$Pr [ i is in the committee \vert GOOD ] \geq \frac{( 1 - ϵ ) c}{n} ,$$

for any honest individual i. The probability is taken over the randomness of the protocol.

Although committee election is a constant-sum game, these two notions of fairness are non-equivalent. See Section A for more explanation.

Finally, we define game-theoretical fairness. This notion of fairness requires CSP and maximin-fairness simultaneously.

Definition 2.6 ((1−ϵ)-game-theoretical fairness). A (c, n)-committee election is (1−ϵ) game-theoretically fair committee election against a non-uniform probabilistic polynomial time (p.p.t.) coalition A, iff it is (1−ϵ)-CSP-fair and (1−ϵ)-maximin-fair against A.
Definition 2.7 ((1−ϵ, δ)-game-theoretical fairness). A (c, n)-committee election is (1−ϵ) game-theoretically fair committee election against a non-uniform probabilistic polynomial time (p.p.t.) coalition A, iff it is (1−ϵ, δ)-CSP-fair and (1−ϵ, δ)-maximin-fair against A.

By definition, a (1−ϵ)-game-theoretically fair committee election is also (1−ϵ, 0)-game-theoretically fair. Next we give the translation from (1−ϵ, δ)-CSP/maximin-fair to (1−ϵ)-CSP/maixin-fair.

Lemma 2.8. Let n be the number of parties and fix a parameter c. Let CElect be an R-round (1−ϵ, δ)-CSP-fair (c, n)-committee election protocol against a coalition of size βn. Then the above leader election protocol is (1−δ₁)-CSP-fair against a coalition of size βn, with a round complexity R+O(log c), where

$${ϵ}_{1} = \frac{βϵ + δ ( 1 - ϵ )}{β + δ ( 1 - ϵ )} + negl ( λ ) .$$

Lemma 2.9. Let n be the number of parties and fix a parameter c. Let CElect be an R-round (1−ϵ, δ)-maximin-fair (c, n)-committee election protocol against a coalition of size βn. The the above leader election protocol is (1−ϵ₂)-maximin-fair, with a round complexity R+O(log c), where

$${ϵ}_{2} = ϵ + δ + negl ( λ ) .$$

Hybrid vs. real worlds. For ease of presentation and modulatiry purposes, we shall sometimes consider protocols in a hybrid setting where we assume some “generic” functionality is given for free. This is called a “hybrid world”. That is, we say that a protocol is in the [symbol] -hybrid world if players interacting in this protocol have access to an ideal functionality [symbol] . A protocol in the (plain) real world is a protocol without any ideal functionalities or setup assumptions. Specifically for us, we say that a (c, n)-committee election protocol achieves (1−ϵ)-game-theoretic fairness against a coalition A in the [symbol] -hybrid world, if the protocol achieves (1−ϵ)-game-theoretic fairness against this coalition A, assuming the ideal functionality [symbol] .

### 2.3 Publicly Verifiable Concurrent Non-Malleable Commitment

A publicly verifiable commitment scheme (C, R, V) consists of a pair of interacting Turing machines, the committer C, the receiver R, and a deterministic, polynomial-time public verifier V. We assume that the protocol has two phases, a commitment phase and an opening phase. The public verifier, upon receiving a transcript Γ of the commitment protocol, outputs either a bit b∈{0, 1} to accept or ⊥ to reject. We use [symbol] C*(z), R*(z′) [symbol] to denote an execution between C* on input z, 1^{λ}, and R* on input z′, 1^{λ}, where λ is the security parameter.
Correctness. Correctness guarantees that an honest committer always completes the protocol and correctly opens its input bit; and will not be stuck by a malicious, non-aborting receiver. Formally, for b∈{0, 1}, for any λ∈ [symbol] , if C is honest and receives input bit b, then [symbol] C(z), R*(z′) [symbol] will complete with the accepting bit b with probability 1, for any non-aborting R*. If the messages sent by R* are outside the valid range, it is treated as aborting.
Perfect Binding. Perfect binding guarantees that the commitment phase will determine only one bit that can be successfully opened. Formally, let (Γ_{c}, Γₒ)∈{0, 1 [symbol] ^{(λ)} be the transcripts of the commitment phase and the opening phase, respectively, where [symbol] (λ) is a fixed polynomial function denoting the maximum length of the transcripts. Then for any λ∈ [symbol] , any transcripts

$${Γ}_{c} , {Γ}_{o} , {Γ}_{o}^{′} ,$$

if V(1^{λ}, Γ_{c}, Γₒ)=b and

$$∨ ( {1}^{λ} , {Γ}_{c} , {Γ}_{o}^{′} ) = {b}^{′} ,$$

where b, b′∈{0, 1}, it must be that b=b′.

Computationally Hiding. Computationally hiding guarantees that at the end of the commitment phase, the receiver learns only a negligible amount of information about the input that the committer commits to. Formally, let p_{λ}(v) denote the probability that R* outputs 1 at the end of the commitment phase in an execution [symbol] C*(1^{λ},v), R*(1^{λ}) [symbol] , then for any non-uniform p.p.t. R*, there exists a negligible function negl(−) such that for every λ∈ [symbol] and every vᵢ, v₂ ∈{0, 1}^{λ}, it holds that |p_{λ}(v₁)−p_{λ}(v₂)|≤negl(λ).

Concurrent Non-malleability. We follow the definition of Lin et al. Consider a man-in-the-middle adversary A that participate on the left m interactions with an honest committer who runs commitment phase committing to values vᵢ, . . . , vₘ with identity id₁, . . . , idₘ, and on the right m interactions with an honest receiver trying to commit to values

$${v}_{1}^{′} , … , {v}_{m}^{′}$$

with identity

$${id}_{1}^{′} , … , {id}_{m}^{′} .$$

If any of the right commitments are invalid its value is set to ⊥. For every i∈[m], if

$${id}_{j}^{′} = {id}_{i}$$

for some j∈[m], then

$${v}_{j}^{′}$$

is set to be ⊥. Let mit [symbol] (1^{λ}, v₁, v₂, . . . , vₘ, z) denote the view of [symbol] and the values

$${v}_{1}^{′} , … , {v}_{m}^{′} .$$

Definition 2.10. A commitment scheme is concurrent non-malleable if for every polynomial p(⋅), for every non-uniform p.p.t. adversary [symbol] that participates in at most m=p(λ) concurrent executions, there exists a polynomial time simulator [symbol] such that

$${\{ {mitm}^{A} ( {1}^{λ} , {v}_{1} , {v}_{2} , … , {v}_{m} , z ) \}}_{{v}_{1} , … , {v}_{m} ∈ {\{ 0 , 1 \}}^{*} , λ ∈ ℕ} {≡}_{c} \\ {\{ 𝒮 ( {1}^{λ} , z ) \}}_{{v}_{1} , … , {v}_{m} ∈ \{ 0 , 1 \} , z ∈ {\{ 0 , 1 \}}^{*} , λ ∈ ℕ} .$$

Theorem 2.11. Assume that one-way permutations exist. Then there exists a constant-round, publicly verifiable commitment scheme that is perfectly correct, perfectly binding, and concurrent non-malleable.

In this application, we will only consider bounded concurrency. Without loss of generality, the number of concurrent calls to public verifiable concurrent non-malleable commitment in our protocol is upper bounded by n², where n is the number of players.

### 3 Game-Theoretically Fair Committee Election

In this section, we present our game-theoretically fair committee election that extends Feige's lightest bin protocol. Later, in Section 4, we will use it as a building block to get our committee election protocol that achieves game-theoretic fairness for arbitrary committee size.

### 3.1 Electing Poly-logarithmically Sized Committees: Achieving CSP-Fairness

In this section, we give a CSP-fair committee election protocol. This is the first step towards our game-theoretically fair committee election (that needs to be CSP-fair and maximin fair, simultaneously).

Our CSP-fair protocol is a commit-and-reveal variant of Feige's well-known lightest bin protocol. Specifically, we require all parties to (cryptographically) commit to their bin choices and only afterward to reveal their choices. The parties whose choices correspond to the lightest bin are the committee. The commitments that we use are interactive. To commit to a string, a player invokes n instances of NMC, one for each of the n receivers. To open the commitments, the committer posts the openings for all n instances in the broadcast channel, and the opening is correct iff all of the n instances are correctly opened to the same string. Without loss of generality, we assume that the committer only needs to send one message in the opening phase. Moreover, we assume that messages are posted to the broadcast channel, and it can be checked publicly if a commitment is correctly opened. This is why we also require public verifiability of the commitment scheme. We say that a player fails to commit if the player fails to commit in an instance, where the receiver is non-aborting.

### LBin-C: Commit-and-Reveal Lightest Bin

Parameters: Let c be an upper bound of the size of the required committee and n is the number of players. Fix

$$B = ⌈ \frac{n}{c} ⌉$$

as the number of bins. For simplicity, we assume c divides n.
Building blocks: A publicly verifiable concurrent non-malleable commitment as in Section 2.3, NMC.

### Protocol:

1. Round 1: Every player i randomly chooses a bin bᵢ∈[B], invokes n NMC instances and run the commit phase with n receivers to commit to bᵢ. The messages are sent in a broadcast channel. Exclude those players who fail to commit.
2. Round 2: Every player i runs the opening phase with n receivers to open its bin choice bᵢ. Exclude those players who fail to open all n instances correctly.
3. Let \hat{b} be the lightest bin after exclusion (break ties with lexicographically the smallest bin). The players who choose bin \hat{b} constitute the committee.
   Theorem 3.1. Assume that NMC is publicly verifiable concurrent non-malleable commitment as in Section 23. For n, c∈ [symbol] , ϵ∈(0, 1/2), and β∈(0, 1), the protocol LBin-C is a constant round (1−2ϵ, δ)-CSP-fair (c, n)-committee election protocol against a coalition [symbol] of size βn, where

$$δ = \frac{n}{c} exp \{ - \frac{{ϵ}^{4}}{2} ( 1 - β ) c \} . \qquad ( 1 )$$

Claim 3.2. Given the bin choices

$${\{ {b}_{i} \}}_{i = 1}^{n}$$

at the end of the commit phase, the fraction of players in [symbol] among the committee \tilde{β} is at most

$$γ := \frac{{f}_{\overline{b}}}{{h}_{{b}^{*}} + {f}_{{b}^{*}}} .$$

Claim 3.3. The distribution of γ in the real experiment Real (denoted as γᵣₑₐₗ) is computationally indistinguishable from that of γ in the hybrid experiment Hyb (denoted as γ_{Hyb})
Claim 3.4. In the hybrid experiment,

$$𝔼 [ γ \vert GOOD ] \leq \frac{β}{( 1 - {ϵ}^{2} ) ( 1 - ϵ )} .$$

Corollary 3.5. Pr[\tilde{β}≤β(1−ϵ²)+ϵ²|GOOD]=1.

### 3.2 Electing Poly-logarithmically Sized Committees: Achieving Maximin-Fairness

In Section 3.1 we gave a commit-and-reveal variant of Feige's lightest bin protocol for committee election and showed that it is CSP-fair. The protocol is, however, not maximin-fair. While the adversary cannot gain too much utility by deviating from the protocol, it can still harm the utility of an honest individual. Specifically, consider the following adversarial strategy. The coalition generates commitments so that the coalition's representations in each bin are equal. Then, when it wants to target at a specific player i to not participate in the committee, it waits to see which bin l was chosen by that honest party and then it refuses to reveal commitments from some other bin l′ which will then be lighter than the bin l chosen by honest player i. This attack prevents an honest individual i from being elected into the committee.

By the properties of the commitment scheme and how our protocol works, this is the only useful attack for the adversary. Thus, we modify our protocol to withstand this attack by masking the identity of parties. Namely, we hide which bin choice belongs to which party. We achieve this by requiring players to choose a random virtual ID and use it throughout the execution. Players will only reveal their virtual IDs at the end of the protocol, after the lightest bin has been fixed. A-priori, it seems hard to implement such a system because once a party sends its message, everybody knows who sent it (recall that we are in the broadcast model). We overcome this by implementing an “anonymous” broadcast channel on top of our existing broadcast channel.

Thus, we first describe our anonymous broadcast functionality

$${ℱ}_{anon}^{t , 𝒪} .$$

Then, we show that in a

$${ℱ}_{anon}^{t , 𝒪}$$

hybrid model, we can build a committee election protocol that ensures CSP-fairness and maximin-fairness simultaneously.

### 3.2.1 Anonymous Broadcast Functionality

Let [symbol] be the set of all players involving in the protocol. Our anonymous broadcast functionality

$${ℱ}_{anon}^{t , 𝒪}$$

works as follows.

$${ℱ}_{anon}^{t , 𝒪}$$

Anonymous broadcast with t-identifiable abort

Parameters: [symbol] is the set of players involving in the protocol and t is a bound on the number of misbehaved players to exclude.

### Functionality:

1. Input: Every player i sends a single message mᵢ or ⊥ to

$${ℱ}_{anon}^{t , 𝒪} .$$

2. Output:

$${ℱ}_{anon}^{t , 𝒪}$$

computes a multiset Out={mᵢ: i∈ [symbol] and mᵢ≠⊥}.
If the number of corrupted players is smaller than t, send (ok, Out) to everyone in [symbol] . Otherwise, send Out to the adversary [symbol] .
   If receives ok from

[symbol]

$${ℱ}_{a n o n}^{t , 𝒪}$$

sends (ok, Out) to every honest player in [symbol] .
Otherwise, it receives a set [symbol] of corrupted IDs of size at least t from the adversary [symbol] , and then send (fail, [symbol] ) to every honest player in [symbol] .

We say that an adversary A is admissible if 1) it sends only one message for each corrupt player, and 2) it either sends ok, or a set of corrupted players of size at least t in Step 2.

The functionality exhibits several appealing properties that are important for us.

Specifically, in the ideal functionality

$${ℱ}_{a n o n}^{t , 𝒪} ,$$

it holds that:
1. Each player can only send one message.
2. The coalition has to choose their messages independently from honest players' messages.
3. The coalition cannot tell which honest player sends which message.
4. The output is either (ok, Out), or (fail, [symbol] ) with a set [symbol] of size at least t.

### 3.2.2 Formal Description of the Protocol

Here we present the formal description of our lightest bin via anonymous broadcast protocol in the

$${ℱ}_{a n o n}^{t , 𝒪}$$

hybrid model.

### LBin-V(c, n, β): Lightest Bin via Anonymous Broadcast

Parameters: Let c be an upper bound of the required committee and n is the number of players. Fix

$$B = ⌈ \frac{n}{c} ⌉$$

as the number of bins. For simplicity, we assume c divides n. Let [symbol] be initialized as [n] that denotes the set of active players. β·n is the maximum size of the coalition for β∈(0, 1).
Building blocks: A publicly verifiable concurrent non-malleable commitment as in Section 2.3, NMC.

### Protocol:

1. Every player i randomly chooses a string vᵢ←{0, 1}^{λ} as its virtual ID, invokes n instances of NMC, and runs the commit phase with n receivers to commit to (i, vᵢ). Exclude those players who fail to commit.
2. Each player randomly chooses a bin bᵢ←[B] with fresh randomness, and sets mᵢ=(bᵢ, vᵢ). Broadcast mᵢ using

$${ℱ}_{a n o n}^{t , 𝒪}$$

with t=└(1−β)n┘.
If the output is (fail, [symbol] ), exclude the players in [symbol] from [symbol] (namely, set [symbol] = [symbol] / [symbol] ). Then, the remaining players (i.e., those in the updated [symbol] ) re-run step b.
If the output is (ok, Out), go to the next step.
3. Let b* be the lightest bin. Every player opens its virtual ID (i, vᵢ). Let U_{b*} be the set of virtual IDs that are unique and choose the lightest bin b*. Those who open the (i, vᵢ) successfully with vᵢ∈U_{b*} are chosen to be the committee.
   Note that in LBin-V, players do not need to commit to their bin choices and then open, since the functionality

$${ℱ}_{a n o n}^{t , 𝒪}$$

guarantees that the malicious coalition has to choose their messages, i.e., bin choices, independently from honest players' messages. In the following theorem we show that the protocol LBin-V described above is both maximin-fair and CSP-fair in the

$${ℱ}_{a n o n}^{t , 𝒪}$$

hybrid model.
Theorem 3.6. Assume that NMC is a publicly verifiable concurrent non-malleable commitment as in Section 2.3. For any n, c∈ [symbol] and ϵ∈(0, 1/2), β∈(0, 1), the committee election protocol LBin-V(c, n, β) is a (1−ϵ, δ)-maximin-fair and a (1−2ϵ, δ)-CSP-fair (c, n)-committee election in the

$${ℱ}_{a n o n}^{t , 𝒪}$$

hybrid model, against a coalition [symbol] of size βn, where

$$δ = \frac{2 n}{( 1 - β ) c} exp \{ - \frac{{ϵ}^{4}}{2} ( 1 - β ) c \} + negl ( λ ) .$$

Moreover, the round complexity of LBin-V is at most

$$\frac{2}{1 - β} + 2 .$$

4 Fairness Amplification Though Iteration

This section gives our final game-theoretically fair committee election and leader election protocols to select arbitrary committee size with good fairness parameters. The committee election protocol LBin-V introduced in Section 3.2 does not achieve fairness with good parameter for arbitrary committee size. For example, if we want to choose a log log n-sized committee from n players using LBin-V, the probability that the GOOD event does not happen is upper bounded by

$$\frac{n}{log log n} exp \{ - \frac{{ϵ}^{4}}{2} log log n \} ,$$

which is even larger than 1. This makes LBin-V not fair enough for electing a small sized-committee.

Therefore, to build a fair committee election protocol that works for arbitrary committee size, we compose LBin-V for multiple iterations, and combine it with the tournament tree protocol if necessary.

We first give the formal description of the tournament tree protocol and its “almost perfect” fairness. Then we give our final committee election protocol that achieves game-theoretic fairness for arbitrary committee size.

### 4.1 Preliminary: Fairness of Tournament Tree Protocol

This section gives a formal description of the tournament tree protocol. Tournament tree protocol Tourn( [symbol] )

Let n be the size of [symbol] .
If n=1, return the single player in [symbol] .
Otherwise, let

$${n}_{1} = ⌊ \frac{n}{2} ⌋ and {n}_{2} = ⌈ \frac{n}{2} ⌉ .$$

Let [symbol] ₁ be the first n₁ players in [symbol] and [symbol] ₂ be the remaining players.
In parallel, run Tourn( [symbol] ₁) and Tourn( [symbol] ₂), and denote the output as [symbol] ₁ and [symbol] ₂, respectively.
The final winner is determined by the duel protocol between [symbol] ₁ and [symbol] ₂ such that [symbol] ᵢ wins with probability n/n. This is described below.
   Duel Protocol between [symbol] ₁ and [symbol] ₂
Let

$$\frac{{k}_{1}}{{k}_{1} + {k}_{2}} and \frac{{k}_{2}}{{k}_{1} + {k}_{2}}$$

be the probability that player [symbol] ₁ and [symbol] ₂ wins, respectively.
Let k=k₁+k₂, and [symbol] =└log k┘. Each player [symbol] ᵢ commits to an f-bit random string that represents some sᵢ∈ [symbol] ₖ for i=1, 2.
Each player [symbol] ᵢ opens its commitment and reveals sᵢ. If s₁+s₂ mod k∈{0, . . . , k₁−1}, player [symbol] ₁ wins. Otherwise, [symbol] ₂ wins.
If a player aborts or fails to open the commitment correctly, it is treated as forfeiting and the other player wins.
   Lemma 4.1 (Theorem 3.5 of Chung et al.). Let n be the number of players and λ be the security parameter. Then, the tournament-tree protocol, when instantiated with a suitable publicly verifiable, non-malleable commitment scheme as defined in Section 2.3, satisfies (1−negl(λ))-CSP-fairness and (1−negl(λ))-maximin-fairness against coalition of arbitrarily sizes. Moreover, the round complexity is O(log n).

### 4.2 The Final Game-Theoretically Fair Committee Election

In this section, we give our fair committee election protocol that works for arbitrary committee size. Our final protocol runs multiple iterations of LBin-V and combines it with the tournament tree protocol if necessary. The

$${ℱ}_{a n o n}^{t , 𝒪}$$

ideal functionality in LBin-V can be instantiated in real-world cryptography, with only a constant round blowup. The instantiation will be given in Section B in supplementary materials.

Let c be the upper bound of the committee size we want to achieve. The final committee election is given below.

### Committee Election Protocol CElect(n, c)

Parameter: Let c be the upper bound of the committee size and R be the round complexity we want to achieve. The initial committee is [symbol] ₀=[n], c₀=n. The fraction of the coalition is β₀=β. Let L≤R be the smallest integer such that log^{(L)} n≤max{2^{R}, c^{0.1}}. Let

$$ϵ = min \{ \frac{1}{{c}^{0.1}} , \frac{1}{{2}^{R}} \} .$$

### Protocol

1. For [symbol] =1, . . . , L−1:
   Let [symbol] =(lo [symbol] n)¹⁰, [symbol] = [symbol] , [symbol] = [symbol] (1−ϵ²)+ϵ².
   Run LBin-V( [symbol] ). That is, we choose a committee [symbol] of size [symbol] =(log [symbol] n)¹⁰ from [symbol] .
   [symbol] = [symbol] +1.
2. If c≥2^{10R}, set c_{L}=c; otherwise, set c_{L}=2^{11R}. Run the committee election LBin-V(c_{L}, [symbol] _{L-1},β_{L-1}) to elect a committee [symbol] _{L} of size at most c_{L}.
3. If c_{L}≥c, run c number of parallel instances of Tourn^{sid} ( [symbol] _{L}) for sid ∈[c]. Let the final committee be the set of elected leaders in these c instances of tournament tree protocol.

Note that in the protocol, [symbol] is just a parameter that passes to LBin-V, together with c and [symbol] . It is not the real fraction of the coalition in committee C [symbol] . Instead, it is the upper bound of the real fraction of the coalition in [symbol] if good event happens in each round up to [symbol] . The parameter [symbol] is only used to set the parameter t of

$${ℱ}_{anon}^{t , 𝒪}$$

in the [symbol] -th LBin-V call.
Theorem 4.2. Assume the existence of enhanced trapdoor permutations and collision-resistant hash functions. Fix n and c. Let L* be the smallest integer such that log(L*) n≤c^{0.1}. Then for any L*≤R≤C₀ log n for some constant C₀, we have that
If c≥2^{10R} there exists an O(R)-round committee election that achieves

$$( 1 - \frac{1}{{c}^{Θ ( 1 )}} )$$

game-theoretic fairness against a non-uniform p.p.t. coalition of size at most

$$( 1 - \frac{{L}^{*}}{Θ ( R )} ) n .$$

If c<2^{10R}, there exists an O(R)-round committee election that achieves

$$( 1 - \frac{1}{{2}^{Θ ( R )}} )$$

game-theoretic fairness against a non-uniform p.p.t. coalition of size at most

$$( 1 - \frac{L}{Θ ( R )} ) n ,$$

where L is the smallest integer such that log^{(L)} n≤2^{R}.

Our final leader election protocol can be gained directly by picking c=1 in Theorem 4.2.

Theorem 4.3. Assume the existence of enhanced trapdoor permutations, and collision-resistant hash functions. Fix n and let log* n≤R≤C log n be the round complexity we want to achieve for some constant C. Then there exists an O(R)-round leader election that achieves

$$( 1 - \frac{1}{{2}^{Θ ( R )}} )$$

game-theoretic fairness against a non-uniform p.p.t. coalition of size at most

$$( 1 - \frac{L}{Θ ( R )} ) n ,$$

where L is the smallest integer such that log^{(L)}n≤2^{R}.

### A Non-Equivalence of Approximate CSP-Fairness and Approximate Maximin-Fairness

Approximate CSP-fairness and approximate maximin-fairness are different, although committee election is a constant-sum game. For example, in a (1−o(1))-CSP-fair (c, n) committee election protocol against a coalition A of size 0.9n, the coalition may exclude a specific individual from being elected. Because the n utility transferred from this honest individual to the coalition is very small compared to the coalition's default utility when playing honestly. On the other hand, in a (1−O(1))-maximin-fair (c, n) committee election against a small coalition A of size O(1), the coalition can transfer

$$\frac{O ( c )}{n}$$

utility from each honest individual, and significantly increase its utility by a Θ(n) factor.

### B Instantiation of the Ideal Functionalities

In this section, we show how to instantiate the ideal functionalities

$${ℱ}_{anon}^{t , 𝒪}$$

used in committee election LBin-V. Recall that the ideal functionality

$${ℱ}_{anon}^{t , 𝒪}$$

receives one message from each player and either sends the set of all messages it receives to everyone or a set of corrupt players of size at least t to everyone. We will first give our protocol in a IdeaIZK*-hybrid model in which players have access to an ideal zero-knowledge proof functionality. Then we use the elegant techniques of Pass to instantiate the protocol with real-world cryptography. Next, we will first describe the IdeaIZK* functionality in Section B.1, and then we will give our protocol in the IdeaIZK*-hybrid world in Section BL.2.

### B.1 Ideal Zero-Knowledge Functionality IdeaIZK*

Basically, IdeaIZK* either sends success to everyone indicating that the proof is correct, or the identity of the prover/verifier who leads to the failure of the proof. Formally,

Ideal Zero-knowledge Functionality IdeaIZK* [x, L, i, j]

The functionality involves n parties 1, . . . , n, and is parametrized with a statement x, the language L, the prover's identity i and the verifier's identity j.
1. If both the prover i and the verifier j are corrupted, receive a bit b from the prover
   i. If b=1, send (success, i, j) to everyone.
2. Receive ok or ⊥ from the verifier j.
3. If received ⊥ from the verifier, send (fail, j) to everyone.
4. Receive w or ⊥ from the prover. [symbol]
5. If [symbol] (x, w)=1, send (success, i, j) to everyone. Otherwise send (fail, i) to everyone.

In an n-party IdeaIZK*-hybrid protocol, the players can invoke the ideal functionality IdeaIZK*[x, L, i, j] between any prover i∈[n] and any verifier j∈[n], and for arbitrary NP language L. Without loss of generality, in every round, there can be at most n² concurrent invocations of IdeaIZK*. Given an n-party IdeaIZK*-hybrid protocol, we can instantiate IdeaIZK* with actual cryptography using the elegant techniques suggested by Pass.

Theorem B.1. (Constant-round, bounded concurrent secure computation). Assume the existence of enhanced trapdoor permutations and collision-resistant hash functions. Then, given an n-party IdeaIZK*-hybrid protocol Π*, in which the number of concurrent calls of IdeaIZK* is upper bounded by a priori known bound m=poly(λ), there exists a real-world protocol Π such that the following hold:
Simulatability: For every real-world non-uniform p.p.t. adversary [symbol] controlling an arbitrary subset of up to n−1 players in Π, there exists a non-uniform p.p.t. adversary [symbol] * in the protocol Π*, such that for any input (x₁, . . . , xₙ), every auxiliary string z∈{0, 1}*,

$${Exec}^{Π , 𝒜} ( {1}^{λ} , {x}_{1} , … , {x}_{n} , z ) {≡}_{c} {Exec}^{{Π}^{*} , {𝒜}^{*}} ( {1}^{λ} , {x}_{1} , … , {x}_{n} , z ) .$$

In the above, the notation Exec [symbol] (or Exec [symbol] ) outputs each honest players' outputs as well as the corrupt players' (arbitrary) outputs.
Round efficiency: The round complexity of Π is at most a constant factor worse than that of Π*.

This real-world protocol is fulfilled by replacing the IdeaIZK* instance with the bounded concurrent zero-knowledge proofs. All the zero-knowledge proof messages are posted to the broadcast channel.

Now it suffices to show how to replace

$${ℱ}_{anon}^{t , 𝒪}$$

with a protocol Ano [symbol] in the IdeaIZK*-hybrid world. In the protocol, we will omit the language L when it is clear from the context.

### B.2 Implementing Anonymous Broadcast Functionality

In this section, we describe how to implement

$${ℱ}_{anon}^{t , 𝒪}$$

in the IdeaIZK*-hybrid model. The protocol makes use of a perfect binding, statistically hiding commitment scheme comm. Also, every player keeps track of two sets, [symbol] ₛ and [symbol] ᵣ, the set of players who fail to share and the set of players who fail to reconstruct, respectively, to guarantee the identifiable abort property. Still, we use [symbol] to represent the set of corrupted players, [symbol] to represent the set of honest players. The number of parallel sessions is set to be λ. The protocol Anon [symbol] is given below.
Anon [symbol] : instantiating

$${ℱ}_{anon}^{t , 𝒪}$$

in the IdeaIZK*-hybrid world

Parameters: Let M=2n be the number of slots. Let [symbol] ₛ, [symbol] ᵣ and Out be initially empty sets. Without loss of generality we assume that [symbol] =[n].

Building blocks: A perfectly binding, computationally hiding commitment scheme comm.
Input: Each player has an input mᵢ∈ [symbol] for a finite field [symbol] with size larger than 2^{λ}. The sum of tuples is computed entry-wise, i.e., (a₁, bᵢ, c₁)+(a₂, b₂, c₂)=(a₁+a₂, b₁+b₁, c₁+c₂).
Preparation Phase Run the following for λ independent, parallel sessions:
1. Player i uniformly randomly choose a nonce midᵢ∈ [symbol] . It then uniformly randomly chooses a slot lᵢ←[M] and computes a vector Sᵢ∈( [symbol] ³)^{M} such that Sᵢ[l]=(0, 0, 0) if l≠lᵢ, and Sᵢ[l]=(mᵢ, midᵢ, 1) if l=lᵢ.
2. Player i then splits Sᵢ into (n−t)-out-of-n Shamir secret shares. Let X_{i,j} be the j-th share of Sᵢ. Let \hat{X}_{i,j}=comm(X_{i,j}, r_{i,j}) where r_{i,j} are fresh randomness. Broadcast the commitments {\hat{X}_{i,j}}_{j∈[n]}.
3. If a player i fails to broadcast the commitments, add i to the set [symbol] ₛ.
   Validation Phase For sid ∈[λ], let *^{sid} denote the variable * in session sid. Player i invoke IdeaIZK*[stmtᵢ,i,j] for each j∈[n], with the statement

$${stmt}_{i} = {\{ {X}_{i , j}^{sid} \}}_{j ∈ [ n ] , sid ∈ [ λ ]} ,$$

and send the witness

$$w = ( {m}_{i} , {mid}_{i} , {\{ {S}_{i}^{sid} \}}_{sid ∈ [ λ ]} , {\{ {X}_{i , j}^{sid} , {r}_{i , j}^{sid} \}}_{j ∈ [ n ] , sid ∈ [ λ ]} )$$

to prove that
For each sid ∈[A], for each j∈[n],

$$( {X}_{i , j}^{sid} , {r}_{i , j}^{sid} )$$

is the correct opening of

$${\hat{X}}_{i , j}^{sid} ;$$

For each sid ∈[A],

$${\{ {X}_{i , j}^{sid} \}}_{j ∈ [ n ]}$$

forms a valid (n−t)-out-of-n secret sharing of

$${S}_{i}^{sid} ;$$

For each sid ∈[λ], the vector Sᵢ^{sid} contains only one non-zero slot (mᵢ, midᵢ, 1).

For each i∈[n], if there exists a j that IdeaIZK*[stmtᵢ, i, j] outputs (fail, i), i.e., the prover fails to prove the statement to receiver j, add i to the set

$${D}_{s}^{sid}$$

for all sid ∈[λ].
Sharing phase Continue the following for A independent, parallel sessions:
1. For j∈[n], player i sends (X_{i,j}, r_{i,j}) to player j.
2. Player i does the following: for every j∈[n]\ [symbol] ₛ, if it receives a message (X_{j,i}, r_{j,i}) that is a correct opening with respect to \hat{X}_{j,i}, record (X_{j,i}, r_{j,i}) and broadcast (ok, i, j). Otherwise, broadcast (complain, i, j) to complain about j.
3. Player i does the following: for all j such that there is a complain (complain, j, i) in Step 2, player i broadcasts the corresponding opening (i, j, X_{i,j}, r_{i,j}).
4. Unless player i broadcasts all correct openings for those players who has sent (complain, j, i) to complain about i, add i to the set [symbol] ₛ.
5. Player i does the following: for j∈[n]\ [symbol] ₛ, if player i sent (complain, i, j) in Step 2, and j broadcast a correct opening (X_{j,i}, r_{j,i}) in Step 3. then record the correct opening (X_{j,i}, r_{j,i}).
   Reconstruction Phase Run the following for λ independent, parallel sessions:
1. Player i computes Yᵢ= [symbol] X_{j,i} and broadcast Yᵢ. If a player j fails to broadcast, add j to the set [symbol] ᵣ.
2. Player i does the following for each j∈[n]: invoke

$${IdealZK}^{*} [ {stmt}_{i}^{′} , i , j ]$$

with the statement stmtᵢ′=( [symbol] ₛ, Yᵢ, {\hat{X}_{j,i} [symbol] ). It sends the witness w′=({X_{j,i}, r_{j,i} [symbol] ) to the ideal functionality IdeaIZK* to prove that [symbol]
For any j∈[n] [symbol] ₛ, (X_{j,i}, r_{j,i}) is a correct opening of \hat{X}_{j,i};
Yᵢ= [symbol] X_{j,i}.
3. If there exists a j such that

$${IdealZK}^{*} [ {stmt}_{i}^{′} , i , j ]$$

outputs (fail, i), i.e., the prover fails to prove the statement to receiver j, add i to the set [symbol] ᵣ.
4. If | [symbol] ᵣ|≥t, everyone stores (fail, [symbol] ᵣ∪ [symbol] ₛ) for the reconstruction phase of this session.
5. Otherwise, every player uses all broadcast shares {Yᵢ [symbol] to reconstruct the sum S= [symbol] Yᵢ. Store (ok, S) for the reconstruction phase of this session.
   Output Phase For each sid ∈[λ], we use (fail, [symbol] ^{sid}) or (ok, S^{sid}) to denote the value each player stores in the reconstruction phase of session sid. Each player i does the following:
1. If there is a sid ∈[λ] such that player i stores (fail, [symbol] ^{sid}) for that session, outputs (fail, ∪_{sid∈[λ]} [symbol] _{sid}), where [symbol] ^{sid}=∅ for those successfully reconstructed sessions.
2. Otherwise, each player does the following: We say that (m, mid) appears in session sid if there exists a slot l∈[M] such that S^{sid} [l]=(m, mid, 1).
   For each pair (m, mid) that appears in a majority number of sessions, add a copy of m to Out.
3. Output (ok, Out).
   Theorem B.2. If the commitment scheme comm is perfectly binding and computationally hiding, then Ano [symbol] securely realizes

$${ℱ}_{a n o n}^{t , 𝒪}$$

in the IdealZK*-hybrid model as long as | [symbol] |-t≥| [symbol] |. Moreover, Ano [symbol] runs in constant number of rounds.

### Blockchain Implementations

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

In addition, while the term “message” may have been used in the description of embodiments, the application may be applied to many types of networks and data. Furthermore, while certain types of connections, messages, and signaling may be depicted in exemplary embodiments, the application is not limited to a certain type of connection, message, and signaling.

Example embodiments provide methods, systems, components, non-transitory computer readable media, devices, and/or networks, which are configured to randomly select member nodes of a next committee for consensus using commitments by member nodes of a current committee. Firstborn blocks of nodes in the current committee can be used to commit to randomly selecting the next committee and also store random values (e.g., random coefficients) that are sampled from a polynomial and stored in the firstborn blocks. Remaining non-committee nodes can pull the firstborn blocks during a blockchain protocol and use a deterministic algorithm to verify the randomness (i.e., that randomness was used and not faked) and also identify the member nodes of the next committee based on the stored random values.

In one embodiment the application utilizes a decentralized database (such as a blockchain) that is a distributed storage system, which includes multiple nodes that communicate with each other. The decentralized database includes an append-only immutable data structure resembling a distributed ledger capable of maintaining records between mutually untrusted parties. The untrusted parties are referred to herein as peers or peer nodes. Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency. In various embodiments, a permissioned and/or a permission-less blockchain can be used. In a public or permission-less blockchain, anyone can participate without a specific identity. Public blockchains can involve native cryptocurrency and use consensus based on various protocols such as Proof of Work (PoW). On the other hand, a permissioned blockchain database provides secure interactions among a group of entities which share a common goal but which do not fully trust one another, such as businesses that exchange funds, goods, information, and the like.

This application can utilize a blockchain that operates arbitrary, programmable logic, tailored to a decentralized storage scheme and referred to as “smart contracts” or “chaincodes.” In some cases, specialized chaincodes may exist for management functions and parameters which are referred to as system chaincode. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincode to specify endorsers for a transaction in the form of a set of peer nodes that are necessary for endorsement. When a client sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

This application can utilize nodes that are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node). Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain, which is another name for the initial blockchain transaction which normally includes control and setup information.

This application can utilize a ledger that is a sequenced, tamper-resistant record of all state transitions of a blockchain. State transitions may result from chaincode invocations (i.e., transactions) submitted by participating parties (e.g., client nodes, ordering nodes, endorser nodes, peer nodes, etc.). Each participating party (such as a peer node) can maintain a copy of the ledger. A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain.

This application can utilize a chain that is a transaction log which is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Since the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

A blockchain network may include many blockchain peers which each hold a copy/replica of a blockchain ledger. Consensus protocols are used by the blockchain network to ensure that the state of the blockchain ledger is consistent across all of the blockchain peers. One algorithm that is commonly used for consensus is practical byzantine fault tolerance (pBFT). In a pBFT consensus, one or more primary peers act as a lead peer for the remaining peers (referred to herein as following peers or consensus peer). Each lead peer maintains an internal state of the blockchain ledger as do the following peers.

Blockchain frameworks may implement a consensus committee which is a subset of nodes from a larger set of all nodes that are member participants of a blockchain network. By only using a subset of nodes for consensus, the amount of messages and verifications that must be performed during block consensus can be significantly reduced. A consensus committee may include a lead member (e.g., selected by the other nodes of the blockchain network, a predetermined protocol, etc.), and one or more following members that also participate in the consensus process.

When a request to store data to the blockchain is received from a client, the lead node creates a proposal and multicasts the proposal to the following nodes of the consensus committee that are grouped with the lead node. Next, the following nodes share the proposal with each other to ensure that there is an agreement on the blockchain proposal. When an agreement is reached, the following nodes (and the lead nodes) commit the blockchain proposal to their internal ledgers, and forward a response to the client. Furthermore, remaining non-committee nodes that are participants in the blockchain are able to pull or otherwise receive the blocks and store them to their respective ledgers.

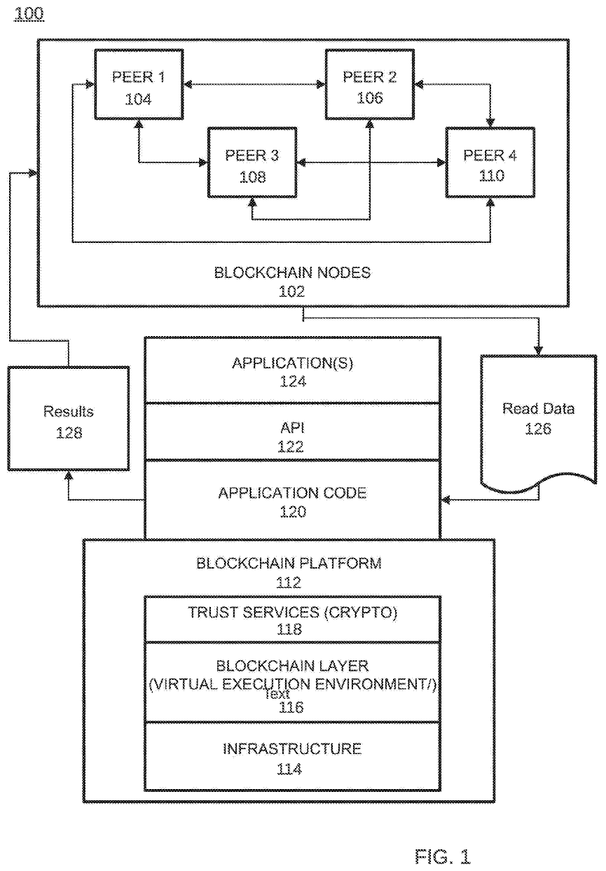

FIG. 1 illustrates a blockchain architecture configuration 100, according to example embodiments. Referring to FIG. 1, the blockchain architecture 100 may include certain blockchain elements, for example, a group of blockchain nodes 102. The blockchain nodes 102 may include one or more nodes 104-110 (these four nodes are depicted by example only). These nodes participate in a number of activities, such as blockchain transaction addition and validation process (consensus). One or more of the blockchain nodes 104-110 may endorse transactions based on endorsement policy and may provide an ordering service for all blockchain nodes in the architecture 100. A blockchain node may initiate a blockchain authentication and seek to write to a blockchain immutable ledger stored in blockchain layer 116, a copy of which may also be stored on the underpinning physical infrastructure 114. The blockchain configuration may include one or more applications 124 which are linked to application programming interfaces (APIs) 122 to access and execute stored program/application code 120 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 104-110.

The blockchain base or platform 112 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 116 may expose an interface that provides access to the virtual execution environment necessary to process the program code and engage the physical infrastructure 114. Cryptographic trust services 118 may be used to verify transactions such as asset exchange transactions and keep information private.

The blockchain architecture configuration of FIG. 1 may process and execute program/application code 120 via one or more interfaces exposed, and services provided, by blockchain platform 112. The code 120 may control blockchain assets. For example, the code 120 can store and transfer data, and may be executed by nodes 104-110 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, the smart contract (or chaincode executing the logic of the smart contract) may read blockchain data 126 which may be processed by one or more processing entities (e.g., virtual machines) included in the blockchain layer 116 to generate results 128 including data to be written to the blockchain. The physical infrastructure 114 may be utilized to retrieve any of the data or information described herein.

A smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into one or more blocks within the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation (e.g., the logic) of a smart contract. For example, the chaincode may include a packaged and deployable version of the logic within the smart contract. As described herein, the chaincode may be program code deployed on a computing network, where it is executed and validated by chain validators together during a consensus process. The chaincode may receive a hash and retrieve from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details.

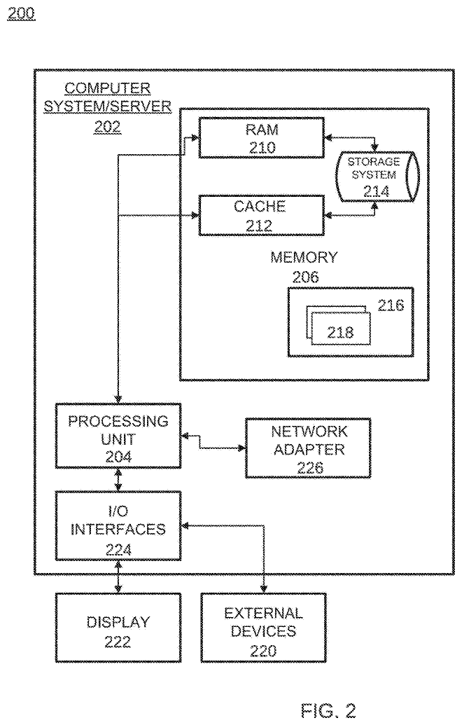

As shown in FIG. 2, computer system/server 202 in cloud computing node 200 is shown in the form of a general-purpose computing device. The components of computer system/server 202 may include, but are not limited to, one or more processors or processing units 204, a system memory 206, and a bus that couples various system components including system memory 206 to processor 204.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 202 typically includes a variety of computer system readable media. Such media may be any available media that is accessible by computer system/server 202, and it includes both volatile and non-volatile media, removable and non-removable media. System memory 206, in one embodiment, implements the flow diagrams of the other figures. The system memory 206 can include computer system readable media in the form of volatile memory, such as random-access memory (RAM) 210 and/or cache memory 212. Computer system/server 202 may further include other removable/non-removable, volatile/non-volatile computer system storage media. By way of example only, storage system 214 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 206 may include at least one program product having a set (e.g., at least one) of program modules that are configured to carry out the functions of various embodiments of the application.

Program/utility 216, having a set (at least one) of program modules 218, may be stored in memory 206 by way of example, and not limitation, as well as an operating system, one or more application programs, other program modules, and program data. Each of the operating system, one or more application programs, other program modules, and program data or some combination thereof, may include an implementation of a networking environment. Program modules 218 generally carry out the functions and/or methodologies of various embodiments of the application as described herein. As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 202 may also communicate with one or more external devices 220 such as a keyboard, a pointing device, a display 222, etc.; one or more devices that enable a user to interact with computer system/server 202; and/or any devices (e.g., network card, modem, etc.) that enable computer system/server 202 to communicate with one or more other computing devices. Such communication can occur via I/O interfaces 224. Still yet, computer system/server 202 can communicate with one or more networks such as a local area network (LAN), a general wide area network (WAN), and/or a public network (e.g., the Internet) via network adapter 226. As depicted, network adapter 226 communicates with the other components of computer system/server 202 via a bus. It should be understood that although not shown, other hardware and/or software components could be used in conjunction with computer system/server 202. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

1. An apparatus comprising:
a memory configured to store blockchain blocks committed to a blockchain based on a protocol executed by a committee of a blockchain network; and
a processor configured for selecting the committee by:
storing c as an upper bound of the size of the committee and n as a number of participants in the committee selection process;
storing
$$B = ⌈ \frac{n}{c} ⌉$$
as a number of bins, wherein c divides n;
establishing a publicly verifiable concurrent non-malleable commitment NMC;
executing a protocol, the protocol comprising:
(a) in a first round, every participant i randomly chooses a bin bᵢ∈[B], invoking n NMC instances and executing a commit phase with n receivers to commit to bᵢ;
every participant transmitting commit phase messages in a broadcast channel;
excluding any participants that fail to commit;
(b) in a second round, every participant i executing an opening phase with n receivers to open its bin choice bᵢ;
excluding those participants who fail to open all n instances correctly;
establishing \hat{b} as the lightest bin after exclusion;
establishing the participants who choose bin b as constituting the committee; and
storing a new block to the blockchain in memory based on a protocol executed by the nodes of the committee.

2. The apparatus of claim 1, wherein the committee and a next committee comprise different respective subsets of nodes from among a larger set of nodes included in the blockchain network.

3. The apparatus of claim 1, wherein the blockchain blocks comprise firstborn blocks created by the nodes of the committee.

4. The apparatus of claim 1, wherein the committee is 1-sized.

5. A apparatus comprising:
a memory configured to store blockchain blocks committed to a blockchain based on a protocol executed by a committee of a blockchain network; and
a processor configured for selecting the committee by:
storing blockchain blocks committed to the blockchain based on a protocol executed by the committee of the blockchain network;
storing c as an upper bound of the committee and n is a number of participants;
storing
$$B = ⌈ \frac{n}{c} ⌉$$
as the number of bins, wherein c divides n;
establishing [symbol] as [n] that denotes a set of active participants;
establishing β·n as a maximum size of a coalition for β∈(0,1);
establishing a publicly verifiable concurrent non-malleable commitment NMC;
executing a protocol, the protocol comprising:
(a) every participant i randomly choosing a string vᵢ←{0, 1}^{λ} as its virtual ID, invoking n instances of NMC, and executing a commit phase with n receivers to commit to (i, vᵢ), wherein those participants who fail to commit are excluded;
(b) each participant randomly choosing a bin bᵢ←[B] with fresh randomness, and
setting mᵢ=(bᵢ, vᵢ);
broadcasting mᵢ using
$${ℱ}_{a n o n}^{t , 𝒪}$$
with t=└(1−β)n┘;
if the output is (fail, [symbol] ), excluding the participants in [symbol] from [symbol] by setting [symbol] = [symbol] \ [symbol] ;
the remaining participants in the updated [symbol] re-run step b.
if the output is (ok, Out), go to the next step;
(c) establishing b* as the lightest bin;
every participant opening its virtual ID (i, vᵢ);
establishing U_{b*} as the set of virtual IDs that are unique and choosing the lightest bin b*;
establishing the committee as those who open the (i, vᵢ) successfully with vᵢ∈U_{b*}; and
storing a new block to the blockchain in memory based on a protocol executed by the nodes of the committee.

6. The apparatus of claim 5, wherein the committee and a next committee comprise different respective subsets of nodes from among a larger set of nodes included in the blockchain network.

7. The apparatus of claim 5, wherein the blockchain blocks comprise firstborn blocks created by the nodes of the current committee.

8. The apparatus of claim 5, wherein the committee is 1-sized.

9. A method comprising:
storing blockchain blocks committed to a blockchain based on a protocol executed by a current committee of a blockchain network;
storing c as an upper bound of the size of the committee and n as a number of participants in the committee selection process;
storing
$$B = ⌈ \frac{n}{c} ⌉$$
as a number of bins, wherein c divides n;
establishing a publicly verifiable concurrent non-malleable commitment NMC;
executing a protocol, the protocol comprising:
(a) in a first round, every participant i randomly chooses a bin bᵢ∈[B], invoking n NMC instances and executing a commit phase with n receivers to commit to bᵢ;
every participant transmitting commit phase messages in a broadcast channel;
excluding any participants that fail to commit;
(b) in a second round, every participant i executing an opening phase with n receivers to open its bin choice bᵢ;
excluding those participants who fail to open all n instances correctly;
establishing \hat{b} as the lightest bin after exclusion;
establishing the participants who choose bin b as constituting the committee; and
storing a new block to the blockchain based on a protocol executed by the nodes of the committee.

10. The method of claim 9, wherein the committee and a next committee comprise different respective subsets of nodes from among a larger set of nodes included in the blockchain network.

11. The method of claim 9, wherein the blockchain blocks comprise firstborn blocks created by the nodes of the committee.

12. The method of claim 9, wherein the committee is 1-sized.

13. A method comprising:
storing blockchain blocks committed to a blockchain based on a protocol executed by a committee of a blockchain network;
a memory configured to store blockchain blocks committed to a blockchain based on a protocol executed by a committee of a blockchain network; and
a processor configured for selecting the committee by:
storing blockchain blocks committed to the blockchain based on a protocol executed by the committee of the blockchain network;
storing c as an upper bound of the committee and n is a number of participants;
storing
$$B = ⌈ \frac{n}{c} ⌉$$
as the number of bins, wherein c divides n;
establishing [symbol] as [n] that denotes a set of active participants;
establishing β·n as a maximum size of a coalition for β∈(0, 1);
establishing a publicly verifiable concurrent non-malleable commitment NMC;
executing a protocol, the protocol comprising:
(a) every participant i randomly choosing a string vᵢ←{0, 1}^{λ} as its virtual ID, invoking n instances of NMC, and executing a commit phase with n receivers to commit to (i, vᵢ), wherein those participants who fail to commit are excluded;
(b) each participant randomly choosing a bin bᵢ←[B] with fresh randomness, and
setting mᵢ=(bᵢ, vᵢ);
broadcasting mᵢ using
$${ℱ}_{a n o n}^{t , 𝒪}$$
with t=└(1−β)n┘;
if the output is (fail, [symbol] ), excluding the participants in [symbol] from [symbol] by setting [symbol] = [symbol] \ [symbol] ;
the remaining participants in the updated [symbol] re-run step b.
if the output is (ok, Out), go to the next step;
(c) establishing b* as the lightest bin;
every participant opening its virtual ID (i, vᵢ);
establishing U_{b}* as the set of virtual IDs that are unique and choosing the lightest bin b*;
establishing the committee as those who open the (i, vᵢ) successfully with vᵢ∈U_{b*}; and
storing a new block to the blockchain based on a protocol executed by the nodes of the committee.

14. The method of claim 13, wherein the committee and a next committee comprise different respective subsets of nodes from among a larger set of nodes included in the blockchain network.

15. The method of claim 13, wherein the blockchain blocks comprise firstborn blocks created by the nodes of the committee.

16. The method of claim 13, wherein the committee is 1-sized.
